(19) United States
(12) Patent Application Publication
(10) Pub. No.: US 2024/0314642 A1
(43) Pub. Date: Sep. 19, 2024

(54) WIRELESS COMMUNICATION SYSTEM AND WIRELESS COMMUNICATION METHOD

(71) Applicant: DENSO CORPORATION, Kariya-city (JP)

(72) Inventors: Sho MATSUMOTO, Kariya-city (JP); Youichi HAYASE, Kariya-city (JP); Yuto HONDA, Kariya-city (JP); Tadashi NAKASHIMA, Kariya-city (JP)

(21) Appl. No.: 18/603,466

(22) Filed: Mar. 13, 2024

(30) Foreign Application Priority Data
Mar. 17, 2023 (JP) 2023-043504

(51) Int. Cl. H04W 28/24; H04B 17/336; H04W 24/10

(52) U.S. Cl. CPC H04W 28/24; H04B 17/336; H04W 24/10

(57) ABSTRACT

A wireless communication system that performs wireless communication between a master device and a slave device is configured to detect characteristic data indicating communication quality in the performed wireless communication, delete the communication channel which is determined not to satisfy a predetermined communication quality standard, determine whether a total number of the plurality of communication channels used for the wireless communication is smaller than a minimum limit value, and change the plurality of communication channels used for the wireless communication to the plurality of communication channels that satisfies a relaxed communication quality standard.

### CROSS REFERENCE TO RELATED APPLICATION

This application is based on Japanese Patent Application No. 2023-043504 filed on Mar. 17, 2023, the disclosure of which is incorporated herein by reference.

### TECHNICAL FIELD

The present disclosure relates to a wireless communication system and a wireless communication method for performing wireless communication between a master device and a slave device via one communication channel that is sequentially selected from multiple communication channels.

### BACKGROUND

This type of wireless communication system is known. In the wireless communication system disclosed in a related art, when an error occurs on a packet and an RSSI value of a radio signal of the packet is larger than a preset threshold Th1, a reception operation, in which the packet is received, is determined to be a reception error due to interference with other radio waves. The number of receptions and the number of reception errors are counted, and frequencies of the reception errors (the number of reception errors/the number of receptions) due to interference in each frequency channel are stored. When a reception error frequency exceeds a threshold Th2, a determination is made that an interference source exists in the frequency channel of which the reception error frequency due to interference exceeds the threshold Th2, and the frequency channel is stored as an unusable channel.

### SUMMARY

A wireless communication system that performs wireless communication between a master device and a slave device is configured to detect characteristic data indicating communication quality in the performed wireless communication, delete the communication channel which is determined not to satisfy a predetermined communication quality standard, determine whether a total number of the plurality of communication channels used for the wireless communication is smaller than a minimum limit value, and change the plurality of communication channels used for the wireless communication to the plurality of communication channels that satisfies a relaxed communication quality standard.

### BRIEF DESCRIPTION OF DRAWINGS

Objects, features and advantages of the present disclosure will become more apparent from the following detailed description made with reference to the accompanying drawings. In the drawings:

FIG. 1 is a block diagram showing a schematic configuration of a wireless communication system according to a first embodiment;

FIG. 2 is a diagram showing an example of electric field intensity distribution in a communication environment between a master device and a slave device;

FIG. 3 is a diagram showing an example of received signal strength of each communication channel;

FIG. 4 is a flowchart showing a communication sequence between the master device and the slave device in the first embodiment;

FIG. 5 is a flowchart showing a detailed example of a deletion determination process of the communication channel in the first embodiment;

FIG. 6 is a diagram showing that two types of thresholds are defined for each of an RSSI value and a PER value, which are characteristic data indicating communication quality;

FIG. 7 is a flowchart showing a detailed example of a channel map creation process in the first embodiment;

FIG. 8 is an explanatory diagram for explaining a process of performing an AND operation on communication channels included in first and second communication channel groups of all the slave devices and calculating an AND operation result; and

FIG. 9 is a flowchart showing a detailed example of a channel map creation process in a second embodiment.

### DETAILED DESCRIPTION

As described above, the wireless communication system disclosed in a related art sets a frequency channel where the communication quality has deteriorated due to interference with other radio waves as an unusable channel. In the wireless communication system disclosed in the related art, the frequency channel, which is set as an unusable channel, is returned to a usable frequency channel after a set period has elapsed.

For example, when the communication environment between a master device and a slave device configuring the wireless communication system is bad, the number of usable frequency channels (communication channels) may be extremely reduced. In this case, channel hopping between multiple communication channels cannot be fully utilized, and an interference avoidance function with external noise may deteriorate.

In the wireless communication system disclosed in a related art, although the communication channel, which is set as an unusable channel, is returned to a usable communication channel after set period has elapsed, when the set time is long, resolving a shortage in the number of communication channels is difficult. On the other hand, when the set time is short, communication errors may occur frequently because there is a high possibility that the wireless communication is performed using the communication channel having deteriorated communication quality. In this way, effectively reducing the occurrence of a shortage in the number of communication channels is difficult by simply returning the communication channel, which is set as an unusable channel, to a usable communication channel when the set time has elapsed.

The present disclosure provides a wireless communication system and a wireless communication method capable of effectively reducing the occurrence of a shortage in the number of communication channels even when a communication channel having deteriorated communication quality is deleted from multiple communication channels used for wireless communication.

According to one aspect of the present disclosure, a wireless communication system that performs wireless communication between a master device and a slave device via one communication channel, which is sequentially selected from a plurality of communication channels is provided. The wireless communication system comprises: a detection unit that detects characteristic data indicating communication quality in the performed wireless communication, for each of the communication channels; a deletion unit that deletes the communication channel, which is determined not to satisfy a predetermined communication quality standard based on the characteristic data detected by the detection unit, from the plurality of communication channels used for the wireless communication; a determination unit that determines, by deleting the communication channel by the deletion unit, whether a total number of the plurality of communication channels used for the wireless communication is smaller than a minimum limit value; and a change unit that changes, when the determination unit determines that the total number of the plurality of communication channels used for the wireless communication is smaller than the minimum limit value, the plurality of communication channels used for the wireless communication to the plurality of communication channels that satisfies a relaxed communication quality standard, which is more relaxed than the predetermined communication quality standard.

According to one aspect of the present disclosure, a wireless communication method of performing wireless communication between a master device and a slave device via one communication channel, which is sequentially selected from a plurality of communication channels is provided. The wireless communication method comprises: a detection step of detecting characteristic data indicating communication quality in the performed wireless communication, for each of the communication channels; a deletion step of deleting the communication channel, which is determined not to satisfy a predetermined communication quality standard based on the characteristic data detected in the detection step, from the plurality of communication channels used for the wireless communication; a determination step of determining, by deleting the communication channel in the deletion step, whether the number of the plurality of communication channels used for the wireless communication is smaller than a minimum limit value; and a change step of changing, when a determination is made in the determination step that the number of the plurality of communication channels used for the wireless communication is smaller than the minimum limit value, the plurality of communication channels used for the wireless communication to the plurality of communication channels that satisfies a relaxed communication quality standard, which is more relaxed than the predetermined communication quality standard.

As described above, in the wireless communication system and wireless communication method according to the present disclosure, when the number of multiple communication channels used for the wireless communication falls below a minimum limit value due to the deletion of communication channels that do not satisfy a predetermined communication quality standard, the multiple communication channels used for the wireless communication are changed to multiple communication channels including a communication channel that satisfies a relaxed communication quality standard that is more relaxed than the predetermined communication quality standard. The relaxed communication quality standard is more relaxed than the predetermined communication quality standard, so the number of communication channels that satisfies the relaxed communication quality standard is increased more than the number of communication channels that satisfies the predetermined communication quality standard. Accordingly, as the multiple communication channels used for the wireless communication, the multiple communication channels in number equal to or larger than the minimum limit value can be easily secured. The increased multiple communication channels satisfy at least the relaxed communication quality standard, so the concern of communication errors can also be reduced.

The following will describe embodiments of the present disclosure with reference to the drawings. Note that the same or similar components are denoted by the same reference numerals throughout a plurality of drawings, and description thereof may be omitted. When only a part of a configuration is described in each embodiment, the configurations of other embodiments previously described can be applied to the other parts of the configuration. In addition to the combination of the configurations explicitly described in the description of each embodiment, the configurations of multiple embodiments may be partially combined even if not explicitly described as long as there is no difficulty in the combination.

### First Embodiment

The wireless communication system of the present embodiment includes a master device and a slave device. At least one of the master device and the slave device may be used while being mounted on a moving object. The moving object includes, for example, a vehicle such as an automobile or a railroad vehicle, a flying object such as an electric vertical takeoff and landing aircraft or a drone, a ship, a construction machine, an agricultural machine, and the like.

As a specific application in a vehicle, the wireless communication system according to the present embodiment can be applied, for example, to a battery management system that manages batteries installed as a battery pack in an electric drive vehicle such as an electric vehicle, a hybrid vehicle, and a plug-in hybrid vehicle. When applied to a battery management system, for example, a master device is connected to a battery control device, and multiple slave devices are respectively connected to a monitoring device provided for each of multiple cell stacks forming a battery pack. In this case, both the master device and the multiple slave devices are mounted on the vehicle.

Each monitoring device provided for each of the multiple cell stacks acquires battery information such as the voltage and current of each battery cell included in the corresponding cell stack and the temperature of the cell stack using various sensors and the like. When each monitoring device receives data requesting the battery information from the battery control device via the wireless communication system, each monitoring device transmits the acquired battery information to the battery control device via the wireless communication system. The battery control device calculates the state of charge (SOC) of the entire cell stack based on the acquired battery information, drives the temperature raising and cooling mechanism in order to adjust the temperature of the battery pack to an appropriate range, and determines whether to execute a so-called equalization process of equalizing the voltages of each battery cell. The battery control device instructs the corresponding monitoring device to execute the equalization process via the wireless communication system when a determination is made that it is necessary to execute the equalization process on at least one cell stack. Each monitoring device performs a process of determining abnormalities in various sensors or abnormalities in the monitoring device's own operations and transmits abnormality information to the battery control device via the wireless communication system when an abnormality is determined.

Alternatively, the wireless communication system according to the present embodiment may be applied to a so-called smart key system or a tire pressure monitoring system in a vehicle. When applied to a smart key system, for example, the master device is mounted on the vehicle and connected to a control device that controls the locking and unlocking of vehicle doors and turning on and off a driving source such as a vehicle engine. The multiple slave devices are installed in mobile keys or mobile terminals owned by multiple users. When applied to a tire pressure monitoring system, the master device is mounted on the vehicle and connected to a control device that displays tire pressure or issues warnings or the like when air pressure is abnormal. The multiple slave devices are provided within each tire and are connected to an air pressure detection device also provided within each tire. The wireless communication system according to the present embodiment may be applied to a vehicle diagnostic system. In this case, for example, the multiple slave devices are connected to multiple in-vehicle equipment equipped with a self-diagnosis function, and the master device is connected to a diagnostic control device installed at a service factory. In these examples, at least one of the master device and the multiple slave devices is disposed at a fixed position, and/or at least one is mounted on the vehicle.

The application example of the wireless communication system according to the present embodiment is not limited to a vehicle, and as described above, the wireless communication system can also be applied to a moving object other than vehicles, for example, to a system for controlling or managing various types of equipment, such as a flying object such as a drone, a ship, a construction machine, and an agricultural machine. The wireless communication system according to the present embodiment can also be applied to a system for controlling or managing various types of equipment in a structure such as a building, a production facility such as a factory, or the like.

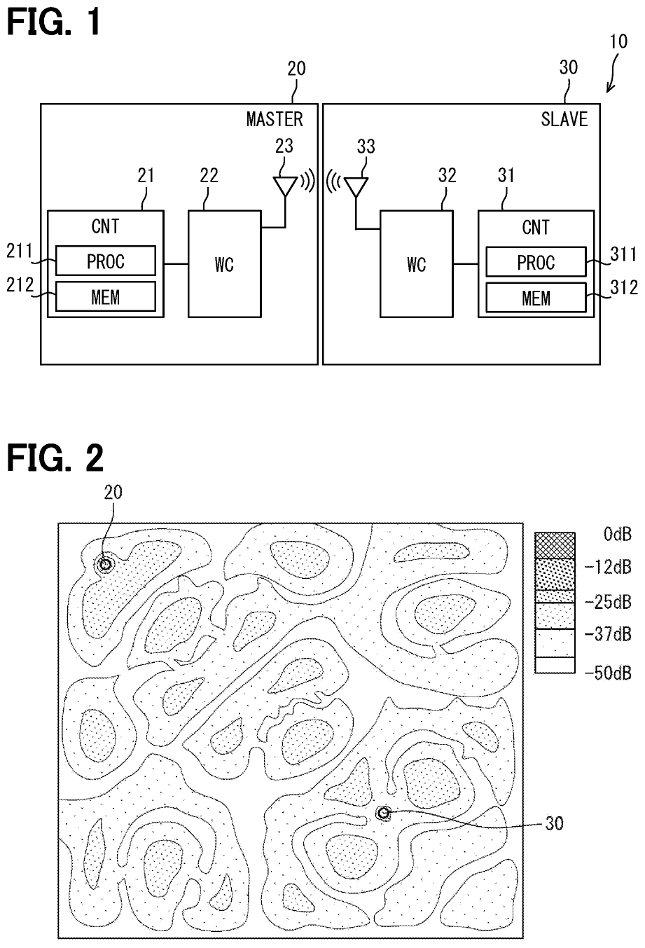

FIG. 1 is a block diagram showing a schematic configuration of the wireless communication system 10. Both the master device 20 and the slave device 30 of the wireless communication system 10 are mounted on, for example, a vehicle (automobile). At this time, the master device 20 and the slave device 30 may be disposed in a common housing or may not be disposed in a common housing. The number of master devices 20 may be one or more. Similarly, the number of slave devices 30 may be one or more. The master device 20 and the slave device 30 perform wireless communication via one communication channel that is sequentially selected from multiple communication channels, such as Bluetooth low energy communication (Bluetooth is a registered trademark, hereinafter referred to as Bluetooth LE), for example.

As an example, the wireless communication system 10 of the present embodiment includes one master device 20 and multiple slave devices 30. Although only one slave device 30 is shown in FIG. 1 for simplification of illustration, all of the multiple slave devices 30 may be configured in the same way.

In the wireless communication between the master device 20 and the slave device 30, a frequency band used for short-range communication, such as a 2.4 GHz band or a 5 GHz band, can be used. Radio waves in such a high frequency band tend to travel more straightly than radio waves in the LF band and are more likely to be reflected by a metal object such as a body of a vehicle. LF is an abbreviation for Low Frequency. As the short-range communication standards, for example, Bluetooth, Bluetooth LE, or the like can be adopted. As an example, the master device 20 and the slave device 30 of the present embodiment are configured to be capable of performing wireless communication (hereafter, referred to as Bluetooth LE communication) based on the Bluetooth LE standard. Details of the communication method related to communication connection, encrypted communication, and the like are performed according to a sequence defined by the Bluetooth LE standard.

As shown in FIG. 1, the master device 20 includes a control circuit (CNT) 21, a wireless communication circuit (WC) 22, and an antenna 23. In addition to the above-described elements, the master device 20 includes an input-output interface or a bus line for wired or wireless communication with devices other than the slave device 30.

The control circuit 21 includes, for example, a processor 211 and a memory 212. The memory 212 includes, for example, RAM and ROM. RAM is an abbreviation for Random Access Memory. ROM is an abbreviation for Read Only Memory.

In the control circuit 21, the processor 211 executes a predetermined process (control) by executing a program stored in the ROM while using the RAM as a temporary storage area. The processor 211 constructs multiple function units by executing multiple instructions included in the program. A storage medium of the program is not limited to ROM. For example, various storage media such as HDD or SSD can be adopted. HDD is an abbreviation for Hard-disk Drive. SSD is an abbreviation for Solid State Drive.

The processor 211 is, for example, a CPU, an MPU, a GPU, a DFP, or the like. CPU is an abbreviation for Central Processing Unit. MPU is an abbreviation for Micro-Processing Unit. GPU is an abbreviation for Graphics Processing Unit. DFP is an abbreviation for Data Flow Processor. The control circuit 21 may be realized by combining multiple types of calculation processing devices such as a CPU, an MPU, and a GPU.

The control circuit 21 may be realized as an SoC. SoC is an abbreviation for System on Chip. The control circuit 21 may be realized using ASIC or FPGA. ASIC is an abbreviation for Application Specific Integrated Circuit. FPGA is an abbreviation for Field-Programmable Gate Array.

The control circuit 21 generates a command requesting a process with respect to the slave device 30 (for example, a command requesting data, a command requesting execution of a predetermined process, or the like) and transmits transmission data including the command to a wireless communication circuit 22 through a transmission packet. The control circuit 21 receives the packet transmitted from the slave device 30 and executes a predetermined process based on the data included in the received packet. That is, the wireless communication performed between the master device 20 and the slave device 30 is packet communication.

The wireless communication circuit 22 includes an RF circuit (not shown) for wirelessly transmitting and receiving packets. The wireless communication circuit 22 has a transmission function of modulating a transmission signal and oscillating the signal at the frequency of an RF signal. The wireless communication circuit 22 has a receiving function of demodulating the received signal. RF is an abbreviation for radio frequency.

The wireless communication circuit 22 modulates the packet containing data transmitted from the control circuit 21 and transmits the packet to the slave device 30 via the antenna 23. The control circuit 21 outputs, to the wireless communication circuit 22, data obtained by encrypting transmission data such as battery information request data using, for example, encryption information exchanged in a connection establishment process described later. The wireless communication circuit 22 adds data necessary for the wireless communication, such as communication control information, to the transmission packet and transmits the transmission packet. The data necessary for the wireless communication includes, for example, an identifier (ID), a sequence number, a next sequence number, an error detection code, and the like. The wireless communication circuit 22 may control data size, communication format, schedule, error detection, or the like of communication between the master device 20 and the slave device 30. The control related to these communications may be performed by the control circuit 21.

The wireless communication circuit 22 receives the packet transmitted from the slave device 30 via the antenna 23 and demodulates the packet. The demodulated packet is transmitted to the control circuit 21. The antenna 23 converts electrical signals into radio waves and radiates the radio waves into space. The antenna 23 receives the radio waves propagating in space and converts the radio waves into electrical signals.

The slave device 30 includes a control circuit (CNT) 31, a wireless communication circuit (WC) 32, and an antenna 33, as shown in FIG. 1. In addition to the above-described elements, the slave device 30 includes an input-output interface or a bus line for wired or wireless communication with devices other than the master device 20. The control circuit 31 has a similar configuration to the control circuit 21 of the master device 20. The control circuit 31 includes, for example, a processor 311 and a memory 312. The memory 312 includes, for example, RAM and ROM.

The control circuit 31 executes the requested process (a response process such as acquiring and returning the requested data, an execution process of the requested process, or the like) based on the requested command acquired via the wireless communication circuit 32. For example, when the requested command, which is included in the received data, is a transmission request for the battery information, the control circuit 31 of the slave device 30 transmits the transmission request to the monitoring device of the corresponding cell stack and acquires the battery information from the monitoring device, and as a response to the request, the control circuit 31 transmits data, which is encrypted by using the encryption information including processing result (for example, the acquired battery information), to the wireless communication circuit 32. The control circuit 31 is also capable of controlling devices mounted on the vehicle, for example, according to the requested process.

The wireless communication circuit 32 includes an RF circuit (not shown) for wirelessly transmitting and receiving packets. The wireless communication circuit 32, like the wireless communication circuit 22, has a transmission function and a receiving function. The wireless communication circuit 32 receives the packet transmitted from the master device 20 via the antenna 33 and demodulates the packet. The data, which is included in the demodulated packet, is transmitted to the control circuit 31. The wireless communication circuit 32 modulates the packet containing data transmitted from the control circuit 31 and transmits the packet to the master device 20 via the antenna 33. The wireless communication circuit 32 adds data necessary for the wireless communication, such as communication control information, to the transmission packet and transmits the transmission packet.

The wireless communication circuit 32 may control data size, communication format, schedule, error detection, or the like of communication between the master device 20 and the slave device 30. The control related to these communications may be performed by the control circuit 31. The antenna 33 converts electrical signals into radio waves and radiates the radio waves into space. The antenna 33 receives the radio waves propagating in space and converts the radio waves into electrical signals.

FIG. 2 is a diagram showing an example of electric field intensity distribution in a communication environment between the master device 20 and the slave device 30. FIG. 2 shows an electromagnetic field simulation result at a predetermined frequency and at predetermined time. Below, the electric field intensity distribution may be referred to as electric field distribution.

The master device 20 and the slave device 30 are disposed at predetermined positions in the vehicle, for example. When a wireless radio wave signal is transmitted at a predetermined frequency from the master device 20 and the slave device 30, which are respectively disposed at predetermined positions, a portion with high electric field intensity and a portion with low electric field intensity are generated in usage environment due to interference between transmission waves and reflected waves or interference with external noise. The reflected waves are caused by reflection from metal elements of the vehicle that are present around the master device 20 and the slave device 30, such as reflection from the vehicle body, reflection from a metal housing, reflection from a harness, and the like. For this reason, in the communication environment between the master device 20 and the slave device 30, there are so-called multiple NULL points, which are portions where the electric field intensity is high and portions where the electric field intensity is low, as shown in FIG. 2.

When the slave device 30 is positioned at or near the portion where the electric field intensity is low in the electric field distribution with the master device 20, there is a high possibility that the slave device 30 is not capable of correctly receiving the radio signal from the master device 20, and a communication error may occur. A communication channel where such a communication error is likely to occur is a communication channel having deteriorated communication quality.

When the master device 20 and the slave device 30 perform the wireless communication via one communication channel that is sequentially selected from the multiple communication channels, the electric field distribution of each communication channel may also be changed because the frequency of each communication channel is different. As a result, the communication quality may vary between each of the communication channels.

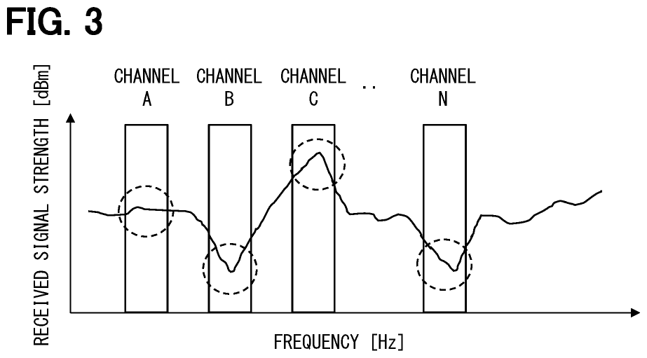

For example, as shown in FIG. 3, in the wireless communication via Communication Channel A, the received electric power (received signal strength), which is one of parameters indicating the communication quality, is good. In the wireless communication via Communication Channel C, the received electric power shows a very high value. Therefore, when the master device 20 and the slave device 30 use Communication Channels A and C with good or very high communication quality, high quality wireless communication with sufficiently limited communication errors may be performed. On the other hand, in the wireless communication via Communication Channels B and N, the received electric power is low. Therefore, when the master device 20 and the slave device 30 use communication channels B and N having deteriorated communication quality, there is a high possibility that a communication error occurs in the wireless communication. In FIG. 3, in order to facilitate understanding, an example of received signal strength with respect to frequency is shown with a solid line.

Therefore, the wireless communication between the master device 20 and the slave device 30 is preferably performed using a communication channel that may perform high quality wireless communication, avoiding a communication channel having deteriorated communication quality.

The electric field distribution between the master device 20 and the slave device 30 is changed depending on the external environment (noise or the like from outside), vibrations (including harness vibration) of the master device 20 and/or the slave device 30, or the like. Therefore, when the master device 20 and the slave device 30 are mounted on the vehicle, the electric field distribution in the communication environment between the master device 20 and the slave device 30 is changed depending on, for example, the vibration of the vehicle or the state of the environment around the vehicle, or the like. As a result, a communication channel having good communication quality and a communication channel having deteriorated communication quality are not fixed and may be changed from time to time. Therefore, there is a requirement to delete the corresponding communication channel from the multiple communication channels used for the wireless communication in response to communication quality deterioration and to restore the corresponding communication channel as one of the multiple communication channels used for the wireless communication in response to communication quality recovery. There is also a requirement to secure the multiple communication channels in number equal to or larger than the minimum limit value as multiple communication channels used for the wireless communication, in order to enable an interference avoidance function with external noise or the like.

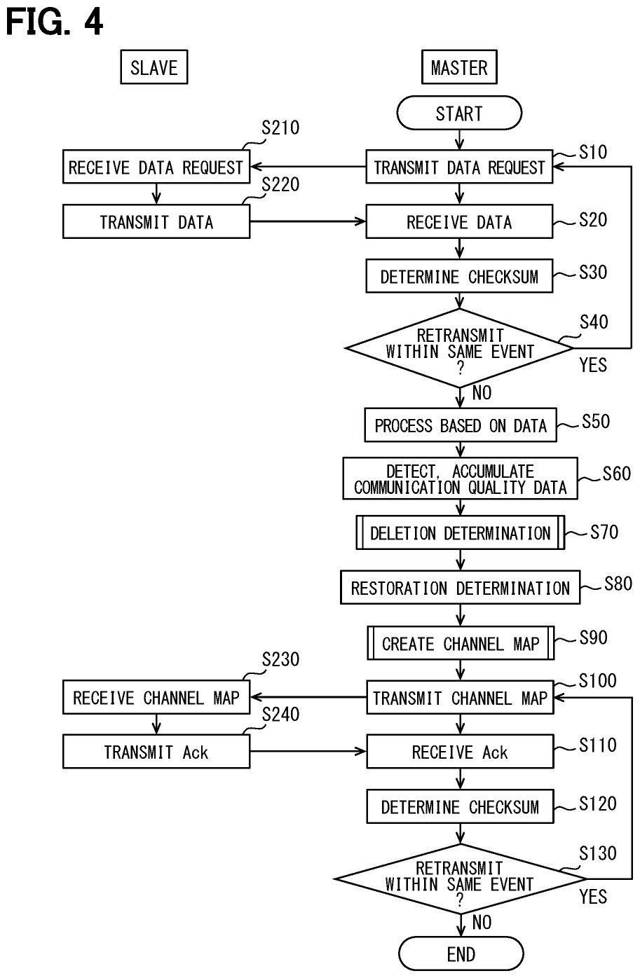

In the wireless communication system 10 of the present embodiment, the description is made with reference to the drawing in which the communication channels having deteriorated communication quality are deleted, the multiple communication channels in number equal to or larger than the minimum limit value is secured as the multiple communication channels used for the wireless communication, and a control process for realizing the wireless communication between the master device 20 and the slave device 30 is shown in a communication sequence between the master device 20 and the slave device 30 shown in FIG. 4. In FIG. 4, the master device 20 is represented as MASTER, and the slave device 30 is represented as SLAVE. FIG. 4 shows the communication sequence performed between the master device 20 and one slave device 30. When there are multiple slave devices 30, the master device 20 individually performs the communication sequence shown in FIG. 4 with the multiple slave devices 30.

First, the master device 20 and the slave device 30 execute a connection establishment process before executing the communication sequence shown in FIG. 4. For example, in a case where the wireless communication system 10 is mounted on the vehicle, for example, when an IG signal is switched from OFF to ON through a user's operation, the connection establishment process is executed. The connection establishment process is executed between the master device 20 and all the slave devices 30, which are connection targets for the wireless communication with the master device 20. When the master device 20 and the slave device 30 are always connected, the connection establishment process is performed only once at predetermined time. When an error occurs during the communication and the wireless communication connection between the master device 20 and the slave device 30 is disconnected, the connection establishment process may be performed for reconnection.

In the connection establishment process, for example, the slave device 30 executes an advertisement operation of transmitting an advertisement signal via an advertising communication channel, and the master device 20 executes a scan operation of scanning the advertisement signal. The advertising communication channel includes multiple communication channels (for example, three in the case of Bluetooth LE). When the master device 20 receives the advertisement signal through the scan operation, the master device 20 transmits a connection request to the slave device 30 in which the advertisement signal is transmitted. Accordingly, the communication connection is established between the master device 20 and the slave device 30. After the communication connection is established, the master device 20 and the slave device 30 exchange the encryption information and perform a process of sharing initial information related to frequency channel hopping. The initial information includes, for example, a hopping pattern or a function for hopping, and the like.

When the connection establishment process is ended, the master device 20 and the slave device 30 execute data communication via data communication channels that are sequentially selected from the multiple communication channels for each communication event that occurs periodically. In the case of Bluetooth LE, thirty-seven communication channels are prepared as the data communication channels. Specifically, as shown in FIG. 4, in step S10, the master device 20 transmits a data request command, that is, a data request, to the slave device 30, for example. When the slave device 30 receives the data request in step S210, the slave device 30 executes a predetermined process necessary for responding, that is, a process of acquiring and transmitting the requested data, in step S220.

For each communication event, the master device 20 and the slave device 30 perform the frequency channel hopping to switch data communication channels to be used, and transmit and receive the data request and transmit and receive the requested data. At this time, the master device 20 and the slave device 30 determine the communication channel to be switched by the frequency channel hopping according to a channel map described later, for example.

The master device 20 receives the requested data in step S20. In step S30, the master device 20 performs, for example, a checksum determination based on the error detection code included in the received data in order to confirm whether the data has been correctly received. In the following step S40, the master device 20 determines whether to execute a process for retransmission within the same communication event when a determination is made in the process of step S30 that the data has not been correctly received. For example, the master device 20 can determine to perform retransmission when there is enough time to perform the retransmission until the end time of the current communication event and can determine not to perform retransmission when there is no time. In step S40, when the master device 20 determines to perform retransmission, the master device 20 re-executes the process from step S10. When a determination is made in the process of step S30 that the data has been correctly received, or when a determination is made in step S40 that the retransmission is not performed, the master device 20 proceeds to the process of step S50.

In step S50, the master device 20 executes the process based on the information included in the received data. When a determination is made in the process of step S30 that the data has not been correctly received, and when a determination is made in step S40 that the retransmission is not performed, the process of step S50 may be omitted, and the process of step S50 may be executed based on the previously received data.

In step S60, the master device 20 detects received signal strength (RSSI) and a packet error rate (PER) as characteristic data indicating the communication quality of the signal received from the slave device 30. PER is a rate indicating a ratio of the number of error packets to the number of packets received by the master device 20 as a percentage. The master device 20 may detect signal-to-noise ratio (SNR)/signal interference-to-noise ratio (SINR) instead of RSSI. For example, the SNR/SINR can be detected by the master device 20 based on the ratio of an RSSI value when a radio signal from the slave device 30 is received and an RSSI value when a radio signal is not received. The master device 20 may detect a bit error rate (BER) instead of PER. The master device 20 stores and accumulates the detected RSSI or SNR/SINR and the PER or BER for each communication channel. The characteristic data, which indicates the communication quality, can also be acquired by the slave device 30 detecting the RSSI, PER, or the like when a signal from the master device 20 is received and transmitting the RSSI, PER, or the like to the master device 20 in addition to or instead of the master device 20 detecting as described above. Step S60 corresponds to a detection unit and a detection step.

In step S70, the master device 20 determines deterioration in the communication quality of the communication channel based on the characteristic data indicating the communication quality detected in step S60. The communication channel, which is determined to have deteriorated communication quality, is deleted from the communication channels used for the wireless communication between the master device 20 and the slave device 30. The communication channel to be deleted is a data communication channel. A deletion determination process of the communication channel will be described in detail later. Step S70 corresponds to a deletion unit and a deletion step.

In step S80, the master device 20 executes a restoration determination of the deleted communication channel through the deletion determination during the time of previous communication events. In the restoration determination, when a predetermined restoration condition is satisfied, the deleted communication channel is restored as a communication channel used for wireless communication. For example, as an example of the predetermined restoration condition, the deleted communication channel may be restored in response to a predetermined amount of time elapsed after deleting the communication channel. Alternatively, as another example of the predetermined restoration condition, the deleted communication channel may be restored as a communication channel used for the wireless communication in response to communication channels, which are adjacent to the deleted communication channel, showing good communication quality. In this way, the communication channel, which is determined to be restorable as a communication channel used for the wireless communication, is actually used for the wireless communication between the master device 20 and the slave device 30. In a case where the communication quality of the communication channel when actually used for the wireless communication remains deteriorated, the communication channel may again be the target of the deletion determination. Step S80 corresponds to a restoration unit.

In step S90, the master device 20 creates a channel map based on the deletion determination result in step S70, the restoration determination result in step S80, and the number of multiple communication channels usable for the wireless communication. In the present embodiment, an example is described in which a common channel map is created for the multiple slave devices 30. A channel map creation process of the present embodiment will be explained in detail later. The channel map may indicate a usable communication channel for the wireless communication or may indicate an unusable communication channel. The channel map may indicate both the usable communication channel and the unusable communication channel. When there is a change in the usable/unusable communication channels due to the creation of the channel map, a frequency channel hopping pattern may be updated. When the frequency channel hopping pattern is not updated, or when the communication channel scheduled for hopping is unusable, for example, the communication channel scheduled next for hopping may be used.

In step S100, the master device 20 transmits the channel map created through the channel map creation process to the slave device 30. In step S230, the slave device 30 receives the channel map transmitted from the master device 20. In step S240, the slave device 30 returns a received confirmation signal (Ack signal) to the master device 20. In step S110, the master device 20 receives the Ack signal from the slave device 30. In step S120, the master device 20 performs, for example, the checksum determination based on the error detection code included in the received Ack signal in order to confirm whether the Ack signal has been correctly received. In the following step S130, the master device 20 determines whether to execute a process for retransmission within the same communication event when a determination is made in the process of step S120 that the data has not been correctly received. In step S130, when the master device 20 determines to perform retransmission, the master device 20 re-executes the process from step S100. When a determination is made in the process of step S120 that the data has been correctly received, or when a determination is made in step S130 that the retransmission is not performed, the master device 20 ends the process shown in the flowchart in FIG. 4. Steps S100, S110, S230 and S240 correspond to a channel map sharing unit.

In this way, the master device 20 and the slave device 30 perform a process of sharing the channel map. The master device 20 may perform the processes from steps S70 to S130 described above for each communication event or may perform each time multiple communication events pass. Further, the processes from steps S70 to S90 may be executed by a processing device other than the master device 20, and the processing results may be provided to the master device 20.

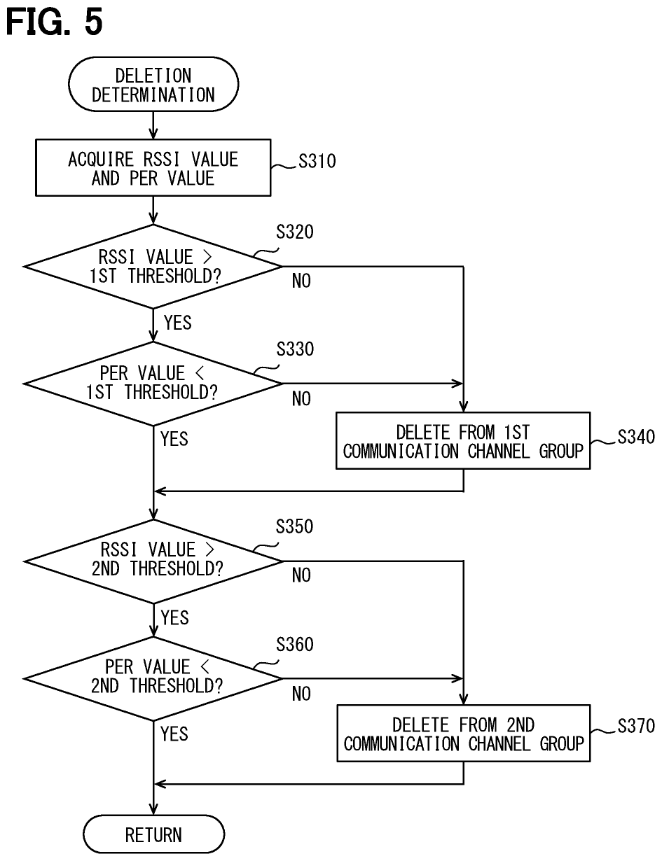

Next, the above described deletion determination process of the communication channel will be described in detail with reference to the flowchart in FIG. 5. The flowchart in FIG. 5 shows a detailed example of the deletion determination process of the communication channel.

In step S310, the master device 20 acquires an RSSI value and a PER value, which are first and second characteristic data indicating the communication quality of the communication channel used for the wireless communication. The larger the RSSI value, the better the communication quality, and the smaller the PER value, the better the communication quality. The RSSI value and the PER value may be an RSSI value and a PER value detected in step S60 when the communication channel has been used for the previous wireless communication, may be values obtained by averaging each of a predetermined number of RSSI values and PER values detected in multiple past wireless communications, or may be median values thereof.

In step S320, the master device 20 determines whether the acquired RSSI value satisfies an RSSI first threshold (is larger than the RSSI first threshold). In the determination process, when a determination is made that the RSSI value satisfies the RSSI first threshold, the master device 20 proceeds to the process of step S330. On the other hand, when a determination is made that the RSSI value does not satisfy the RSSI first threshold, the master device 20 proceeds to the process of step S340.

In step S330, the master device 20 determines whether the acquired PER value satisfies a PER first threshold (is smaller than the PER first threshold). In the determination process, when a determination is made that the PER value satisfies the PER first threshold, the master device 20 proceeds to the process of step S350. In this case, the communication quality of the communication channel may be determined not to have deteriorated, so the communication channel is not deleted from a first communication channel group. On the other hand, when a determination is made that the PER value does not satisfy the PER first threshold, the master device 20 proceeds to the process of step S340.

In step S340, as a result of comparing the RSSI value with the RSSI first threshold or as a result of comparing the PER value with the PER first threshold, either the RSSI value or the PER value does not satisfy the first threshold, so the master device 20 deletes the communication channel from the first communication channel group. The first communication channel group is a collection of the communication channels in which the RSSI value is larger than the RSSI first threshold and the PER value is smaller than the PER first threshold. In other words, the first communication channel group is a collection of the communication channels determined to have good communication quality based on the RSSI value and the PER value.

In this way, in the deletion determination process, when both the RSSI value and the PER value satisfy the respective first thresholds corresponding to a predetermined communication quality standard, the communication channel is determined to satisfy the predetermined communication quality standard and remains to belong to the first communication channel group. Otherwise, when at least one of the RSSI value and the PER value does not satisfy the respective first thresholds, the communication channel is determined not to satisfy the predetermined communication quality standard and is deleted from the first communication channel group.

In step S350, the master device 20 determines whether the RSSI value satisfies an RSSI second threshold, which is smaller than the RSSI first threshold (is larger than the RSSI second threshold). In the determination process, when a determination is made that the RSSI value satisfies the RSSI second threshold, the master device 20 proceeds to the process of step S360. On the other hand, when a determination is made that the RSSI value does not satisfy the RSSI second threshold, the master device 20 proceeds to the process of step S370.

In step S360, the master device 20 determines whether the PER value satisfies a PER second threshold that is larger than the PER first threshold (is smaller than the PER second threshold). In the determination process, when a determination is made that the PER value satisfies the PER second threshold, the master device 20 ends the deletion determination process. In this case, the communication quality of the communication channel may be determined not to have deteriorated below a relaxed communication quality standard corresponding to the respective second thresholds, so the communication channel is not deleted from a second communication channel group. On the other hand, when a determination is made that the PER value does not satisfy the PER second threshold, the master device 20 proceeds to the process of step S370.

In step S370, as a result of comparing the RSSI value with the RSSI second threshold or as a result of comparing the PER value with the PER second threshold, either the RSSI value or the PER value does not satisfy the second threshold, so the master device 20 deletes the communication channel from the second communication channel group. The second communication channel group is a collection of the communication channels in which the RSSI value is larger than the RSSI second threshold and the PER value is smaller than the PER second threshold.

In this way, in the deletion determination process, when both the RSSI value and the PER value satisfy the respective second thresholds corresponding to the relaxed communication quality standard that is more relaxed than the predetermined communication quality standard, the communication channel is determined to satisfy the relaxed communication quality standard and remains to belong to the second communication channel group. Otherwise, when at least one of the RSSI value and the PER value does not satisfy the respective second thresholds, the communication channel is determined not to satisfy the relaxed communication quality standard and is deleted from the second communication channel group.

A relationship between the first communication channel group and the second communication channel group will be described in detail based on the drawings. In the present embodiment, two types of data of the RSSI value and the PER value are detected as the characteristic data indicating the communication quality of the communication channel, and two types of thresholds corresponding to each of the predetermined communication quality standard and the relaxed communication quality standard (first threshold for RSSI, second threshold for RSSI, first threshold for PER, second threshold for PER) are determined for the detected RSSI value and PER value.

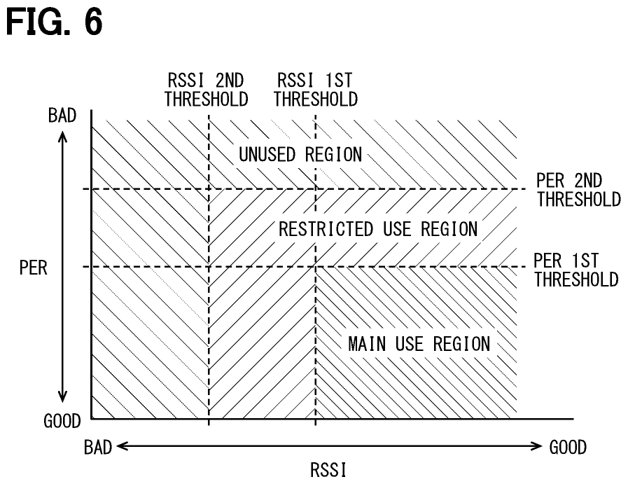

As shown in FIG. 6, the RSSI first threshold is larger than the RSSI second threshold. The larger the RSSI value, the better the communication quality. That is, from the viewpoint of determining deterioration in communication quality, the RSSI second threshold determines larger deterioration in communication quality than the RSSI first threshold. Therefore, it can be said that the RSSI second threshold is more relaxed than the RSSI first threshold.

As shown in FIG. 6, the PER first threshold is smaller than the PER second threshold. The smaller the PER value, the better the communication quality. Therefore, as in the case of RSSI, from the viewpoint of determining deterioration in communication quality, the PER second threshold determines larger deterioration in communication quality than the PER first threshold. Therefore, it can be said that the PER second threshold is more relaxed than the PER first threshold.

In the present embodiment, as shown in FIG. 6, a region having good communication quality, where the RSSI value is larger than the RSSI first threshold and where the PER value is smaller than the PER first threshold, is defined as a main use region. A collection of communication channels belonging to the main use region is defined as the first communication channel group. On the other hand, a region, where the RSSI value is equal to or smaller than the RSSI first threshold and is larger than the RSSI second threshold and where the PER value is equal to or larger than the PER first threshold and is smaller than the PER second threshold, is defined as a restricted use region. As described later, the communication channels belonging to the restricted use region are used for the wireless communication only when the number of communication channels belonging to the main use region is equal to or smaller than the minimum limit value. A collection of communication channels belonging to the main use region and the restricted use region is defined as the second communication channel group. That is, the second communication channel group includes communication channels of the first communication channel group and further includes communication channels belonging to the restricted use region.

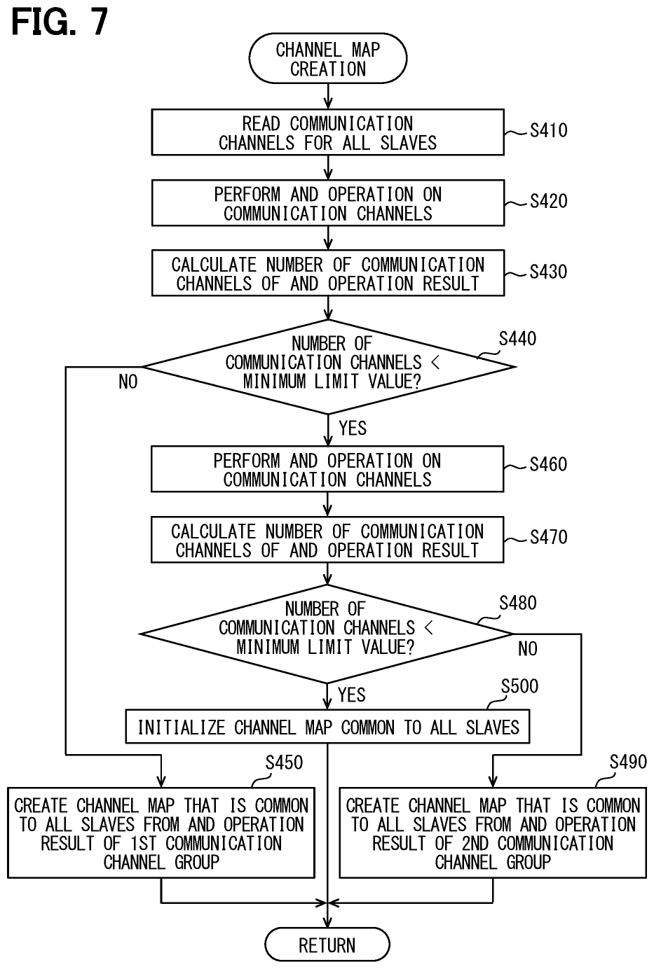

Next, the above-described channel map creation process will be described in detail with reference to the flowchart in FIG. 7. The flowchart in FIG. 7 shows a detailed example of the channel map creation process. As described above, the channel map creation process of the present embodiment is for creating a common channel map for the multiple slave devices 30.

In step S410, after the deletion determination process in step S70 and the restoration determination process in step S80 are performed, the master device 20 reads the communication channels belonging to the first communication channel group and the communication channels belonging to the second communication channel group for all the slave devices 30.

As described using the flowchart in FIG. 5, in the deletion determination process, the communication channel in which the communication quality does not satisfy the predetermined communication quality standard is deleted from the first communication channel group, and the communication channel that does not satisfy the relaxed communication quality standard is deleted from the second communication channel group. Conversely, the collection of communication channels that satisfy the predetermined communication quality standard is stored as the first communication channel group, and the collection of communication channels that satisfy the relaxed communication quality standard is stored as the second communication channel group. These first communication channel group and second communication channel group are stored separately for each slave device 30 in the master device 20.

In the restoration determination process performed for each slave device 30, when a determination is made that the communication channel is restorable, the master device 20 adds the communication channel determined to be restorable to both the first communication channel group and the second communication channel group stored for the corresponding slave device 30. In this way, the communication channels, which is included in the first communication channel group and the second communication channel group, are updated for each slave device 30 through the deletion determination process and/or the restoration determination process.

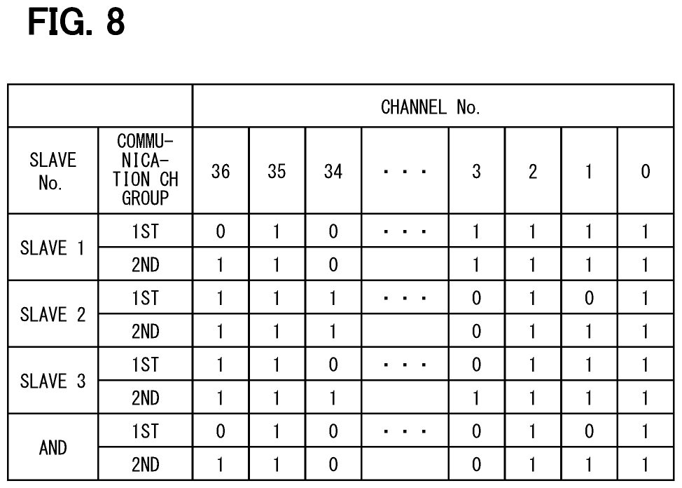

In step S420, the master device 20 performs an AND operation on the communication channels included in the first communication channel group of all the slave devices 30, and calculates an AND operation result. For example, as shown in FIG. 8, as the multiple slave devices 30, when Slave 1 to Slave 3 are provided, the communication channels belonging to all of the first communication channel group of Slave 1, the first communication channel group of Slave 2, and the first communication channel group of Slave 3 are calculated as the AND operation result of the first communication channel group. The example of FIG. 8 shows that CH35, CH2, CH0, or the like are calculated as the AND operation result of the first communication channel group. In FIG. 8, the communication channels included in each communication channel group are indicated by “1”, and the communication channels not included are indicated by “0”.

In step S430, the master device 20 calculates the number of communication channels obtained as the AND operation result for the first communication channel group. In step S440, the master device 20 determines whether the calculated number of communication channels is smaller than the minimum limit value. The minimum limit value defines the number of communication channels considered necessary to avoid interference with external noise. The reason is because in a case where the communication channels used for the wireless communication are switched by channel hopping when the number of communication channels that can be used for the wireless communication is small, the channel hopping between the multiple communication channels cannot be fully utilized, and the interference avoidance function with external noise or the like may deteriorate.

In step S440, when a determination is made that the calculated number of communication channels is equal to or larger than the minimum limit value, the master device 20 proceeds to the process of step S450, and when a determination is made that the calculated number of communication channels is smaller than the minimum limit value, the process proceeds to step S460. In step S450, the channel map, which is common to all the slave devices 30, is created from the multiple communication channels calculated by using the AND operation of the first communication channel group.

In step S460, the master device 20 performs the AND operation on the communication channels included in the second communication channel group of all the slave devices 30, and calculates the AND operation result. Regarding the AND operation on the second communication channel group, similar to the AND operation on the first communication channel group, the communication channels belonging to all of the second communication channel group of Slave 1, the second communication channel group of Slave 2, and the second communication channel group of Slave 3 are calculated as the AND operation result of the second communication channel group. The example of FIG. 8 shows that, as the AND operation result of the second communication channel group, CH36, CH1, or the like are calculated in addition to CH35, CH2, and CH0, which are the AND operation results of the first communication channel group. In this way, the number of communication channels calculated by using the AND operation on the second communication channel group is increased from the number of communication channels calculated by using the AND operation on the first communication channel group.

In step S470, the master device 20 calculates the number of communication channels obtained as the AND operation result for the second communication channel group. In step S480, the master device 20 determines whether the calculated number of communication channels is smaller than the minimum limit value. This minimum limit value is the same as the minimum limit value in step S440. In step S480, when a determination is made that the calculated number of communication channels is equal to or larger than the minimum limit value, the master device 20 proceeds to the process of step S490, and when a determination is made that the calculated number of communication channels is smaller than the minimum limit value, the process proceeds to step S500.

In step S490, the channel map, which is common to all the slave devices 30, is created from the multiple communication channels calculated by using the AND operation of the second communication channel group. On the other hand, in step S500, the number of communication channels included in the second communication channel group is smaller than the minimum limit value, and even with the relaxed communication quality standard, the number of communication channels, which is equal to or larger than the minimum limit value, cannot be obtained, so the channel map that is common to all the slave devices 30 is initialized. That is, the common channel map is initialized to include all the communication channels for data.

As described above, in the present embodiment, when the number of multiple communication channels used for the wireless communication falls below a minimum limit value due to the deletion of communication channels that do not satisfy a predetermined communication quality standard, the multiple communication channels used for the wireless communication are changed to multiple communication channels including a communication channel that satisfies a relaxed communication quality standard that is more relaxed than the predetermined communication quality standard. The relaxed communication quality standard is more relaxed than the predetermined communication quality standard, so the number of communication channels that satisfies the relaxed communication quality standard is increased more than the number of communication channels that satisfies the predetermined communication quality standard. Accordingly, as the multiple communication channels used for the wireless communication, the multiple communication channels in number equal to or larger than the minimum limit value can be easily secured. The increased multiple communication channels satisfy at least the relaxed communication quality standard, so the concern of communication errors can also be reduced.

### Second Embodiment

Next, a wireless communication system according to a second embodiment of the present disclosure will be described with reference to the drawings. The wireless communication system according to the present embodiment is configured in the same manner as the wireless communication system according to the first embodiment, so a description regarding the configuration will be omitted.

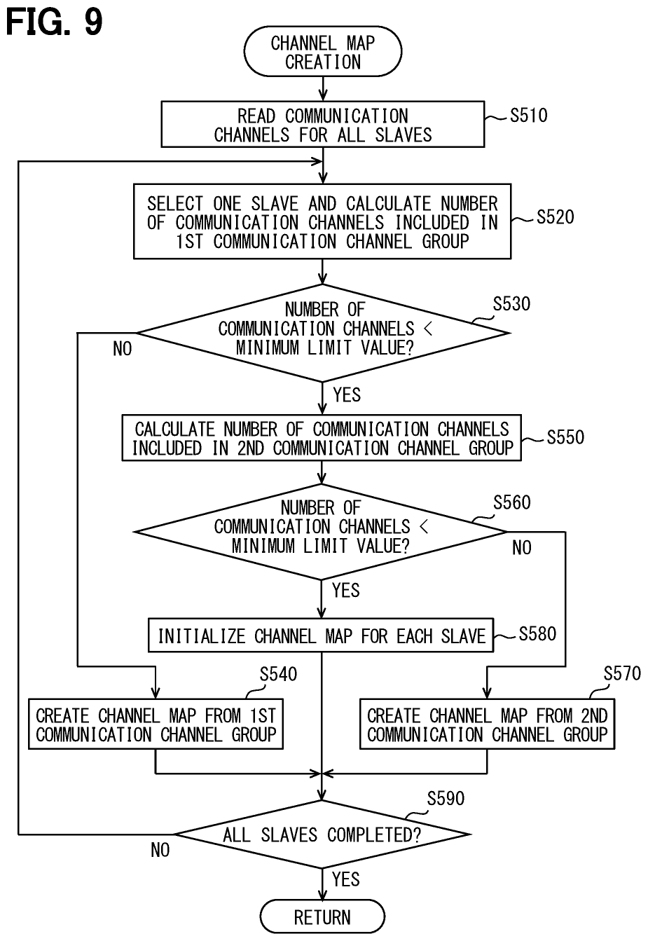

The wireless communication system according to the first embodiment creates the common channel map for all the slave devices 30. In contrast, the wireless communication system according to the second embodiment creates the channel maps individually for the multiple slave devices 30. Therefore, the wireless communication system according to the second embodiment and the wireless communication system according to the first embodiment differ only in the channel map creation process. The channel map creation process performed in the wireless communication system according to the present embodiment will be described below with reference to the flowchart of FIG. 9.

In step S510, after the deletion determination process in step S70 and the restoration determination process in step S80 are performed, the master device 20 reads the communication channels belonging to the first communication channel group and the communication channels belonging to the second communication channel group for all the slave devices 30.

In step S520, the master device 20 selects one slave device 30 from the multiple slave devices 30 and calculates the number of communication channels included in the first communication channel group of the selected slave device. In step S530, the master device 20 determines whether the calculated number of communication channels is smaller than the minimum limit value. The minimum limit value of the present embodiment is the same as the minimum limit value of the first embodiment.

In step S530, when a determination is made that the calculated number of communication channels is equal to or larger than the minimum limit value, the master device 20 proceeds to the process of step S540, and when a determination is made that the calculated number of communication channels is smaller than the minimum limit value, the process proceeds to step S550. In step S540, the channel map for the slave device 30 selected in step S520 is created from the multiple communication channels belonging to the first communication channel group. Step S530 and step S440 correspond to a determination unit and a determination step.

In step S550, the master device 20 calculates the number of communication channels included in the second communication channel group. In step S560, the master device 20 determines whether the calculated number of communication channels is smaller than the minimum limit value. The minimum limit value is the same as the minimum limit value in step S530. In step S560, when a determination is made that the calculated number of communication channels is equal to or larger than the minimum limit value, the master device 20 proceeds to the process of step S570, and when a determination is made that the calculated number of communication channels is smaller than the minimum limit value, the process proceeds to step S580. Steps S460 to S490 and steps S550 to S570 correspond to a change unit and a change step. Step S500 and step S580 correspond to an initialization unit.

In step S570, the channel map for the slave device 30 selected in step S520 is created from the multiple communication channels belonging to the second communication channel group. On the other hand, in step S590, even with the relaxed communication quality standard, the number of communication channels, which is equal to or larger than the minimum limit value, cannot be obtained, so the channel map for the slave device 30 selected in step S520 is initialized.

In step S590, all the slave devices 30 are selected, and a determination is made whether creation of individual channel maps for all the slave devices 30 has been completed. In step S590, when a determination is made that the creation of individual channel maps for all the slave devices 30 has been completed, the process shown in the flowchart in FIG. 9 is ended. On the other hand, when a determination is made that the creation of individual channel maps for all the slave devices 30 has not been completed, the process returns to step S520, the slave device 30 for which channel map creation has not been completed is selected, and the processes of steps S520 to S590 described above are repeated.

According to the second embodiment described above, similar to the first embodiment, an effect can be achieved in which the multiple communication channels in number equal to or larger than the minimum limit value can be easily secured as multiple communication channels used for the wireless communication. The increased multiple communication channels satisfy at least the relaxed communication quality standard, so an effect can be achieved in which the concern of communication errors can also be reduced. In the second embodiment, the channel maps are created individually for the multiple slave devices 30, so the channel map creation process becomes easier, and the multiple communication channels in number equal to or larger than the minimum limit value can be easily secured.

Although the preferred embodiments of the present disclosure have been described above, the present disclosure is not limited to the embodiments described above, and can be implemented with various modifications without departing from the gist of the present disclosure. Some modifications of the present disclosure are shown below.

### Modification 1

In the first embodiment described above, an example in which the PER value is used as the second characteristic data, that is, an example in which two types of characteristic data are used, has been described by using the RSSI value as the first characteristic data indicating communication quality. There may be only one type of characteristic data indicating communication quality instead of two or more types.

### Modification 2

In the first and second embodiments described above, when a determination is made that the communication quality has deteriorated based on characteristic data indicating communication quality (RSSI value, PER value, or the like), only the communication channel is deleted, which is used for the communication for which the characteristic data is detected.

The communication channel, which is determined to have deteriorated communication quality and is deleted from the communication channels for performing the wireless communication between the master device 20 and the slave device 30, may include a neighboring communication channel of the corresponding communication channel in addition to the communication channel, which may be directly determined to have deteriorated communication quality based on the detected characteristic data (RSSI value, PER value, or the like). The reason is because when a determination is made that one communication channel has deteriorated communication quality, usually, there is a high possibility that the communication quality of the communication channel of the nearby frequency shows a similar tendency. In this case, for example, the number of communication channels to be deleted may be increased in a case where both the RSSI value and the PER value do not satisfy the threshold rather than in a case where either one of the RSSI value or the PER value does not satisfy the threshold.

### Modification 3

In the first and second embodiments described above, PER is used as the second characteristic data. However, instead of the error rate of packet communication, a packet arrival rate (PAR), which is the success rate of the packet communication, can also be used. When PAR is used, the magnitude relationship with the threshold or the magnitude relationship between the average value and the instantaneous value is opposite to that in the first and second embodiments described above.

### Modification 4

In the second embodiment described above, although an example has been shown in which channel maps for the multiple slave devices 30 are created all at once, the creation of channel maps may be performed for the multiple slave devices 30 at different time. For example, the channel map creation process for the slave device 30, from which the communication channel is deleted, may be performed, and the channel maps for the other slave devices 30 may be maintained as the channel maps in response to the communication channel being deleted.

### Modification 5

In the first and second embodiments described above, in the first process of the channel map creation process (steps S410 and S510), the communication channels belonging to the first communication channel group and the communication channels belonging to the second communication channel group of all slave devices 30 are read. However, the communication channels belonging to the first communication channel group may be read first, and when the number of communication channels does not satisfy the minimum limit value, the communication channels belonging to the second communication channel group may be read. In the second embodiment, as described in Modification 4,when the channel map creation processes are individually performed, only the communication channels belonging to the first communication channel group and the communication channels belonging to the second communication channel group of the slave device 30, which is a target of the channel map creation process, may be read.

What is claimed is:

1. A wireless communication system that performs wireless communication between a master device and a slave device via one communication channel, which is sequentially selected from a plurality of communication channels, the wireless communication system comprising:
a detection unit that detects characteristic data indicating communication quality in the performed wireless communication, for each of the communication channels;
a deletion unit that deletes the communication channel, which is determined not to satisfy a predetermined communication quality standard based on the characteristic data detected by the detection unit, from the plurality of communication channels used for the wireless communication;
a determination unit that determines, by deleting the communication channel by the deletion unit, whether a total number of the plurality of communication channels used for the wireless communication is smaller than a minimum limit value; and
a change unit that changes, when the determination unit determines that the total number of the plurality of communication channels used for the wireless communication is smaller than the minimum limit value, the plurality of communication channels used for the wireless communication to the plurality of communication channels that satisfies a relaxed communication quality standard, which is more relaxed than the predetermined communication quality standard.

2. The wireless communication system according to claim 1, wherein
the deletion unit generates a first communication channel group configured with the plurality of communication channels, which remains after deleting the communication channel that does not satisfy the predetermined communication quality standard, and a second communication channel group configured with the plurality of communication channels, which remains after deleting the communication channel that does not satisfy the relaxed communication quality standard, and
when the determination unit determines that a total number of the plurality of communication channels included in the first communication channel group is smaller than the minimum limit value, the change unit changes the plurality of communication channels used for the wireless communication to the plurality of communication channels included in the second communication channel group.

3. The wireless communication system according to claim 1, wherein
the determination unit also determines, when the plurality of communication channels used for the wireless communication is changed by the change unit, whether a total number of the changed plurality of communication channels is smaller than the minimum limit value, and
the wireless communication system further comprises:
an initialization unit that initializes, when the determination unit determines that the total number of the plurality of communication channels changed by the change unit is smaller than the minimum limit value, the plurality of communication channels used for the wireless communication to a plurality of initial communication channels.

4. The wireless communication system according to claim 1, further comprising:
a channel map sharing unit that causes, when the determination unit determines that the total number of the plurality of communication channels is equal to or larger than the minimum limit value, the master device and the slave device to share a channel map indicating the plurality of communication channels, which is a determination target.

5. The wireless communication system according to claim 1, further comprising:
a restoration unit that restores, when a predetermined restoration condition is satisfied related to a communication channel that has been deleted by the deletion unit, the deleted communication channel to the plurality of communication channels used for the wireless communication.

6. The wireless communication system according to claim 1, wherein
the characteristic data, which is detected for each of the communication
the deletion unit determines that, when both the first characteristic data and the second characteristic data satisfy each of first thresholds corresponding to the predetermined communication quality standard, a corresponding communication channel satisfies the predetermined communication quality standard, and determines that, when at least one of the first characteristic data and the second characteristic data does not satisfy each of the first thresholds, a corresponding communication channel does not satisfy the predetermined communication quality standard.

7. The wireless communication system according to claim 6, wherein
the deletion unit determines that, when both the first characteristic data and the second characteristic data satisfy each of second thresholds, which indicates communication quality lower than communication quality indicated by each of the first thresholds, corresponding to the relaxed communication quality standard, the corresponding communication channel satisfies the relaxed communication quality standard, and determines that, when at least one of the first characteristic data and the second characteristic data does not satisfy each of the second thresholds, the corresponding communication channel does not satisfy the relaxed communication quality standard.

8. The wireless communication system according to claim 1, wherein
a plurality of the slave devices is provided,
the master device performs the wireless communication with each of the plurality of slave devices,
the determination unit calculates the total number of the plurality of communication channels used for the wireless communication to be compared with the minimum limit value as a total number of the communication channels usable by all of the plurality of slave devices, and
the plurality of communication channels used for the wireless communication is shared for the plurality of slave devices.

9. The wireless communication system according to claim 1, wherein
a plurality of the slave devices is provided,
the master device performs the wireless communication with each of the plurality of slave devices,
the determination unit calculates the total number of the plurality of communication channels used for the wireless communication to be compared with the minimum limit value, for each of the plurality of slave devices, and
the plurality of communication channels used for the wireless communication is individually set for the plurality of slave devices.

10. The wireless communication system according to claim 1, wherein
the wireless communication is packet communication, and
the characteristic data is at least one of received signal strength, signal-to-noise ratio/signal interference-to-noise ratio, packet error rate, packet arrival rate, and bit error rate in the packet communication.

11. The wireless communication system according to claim 1, wherein
at least one of the master device and the slave device is mounted on a moving object.

12. The wireless communication system according to claim 11, wherein
the moving object is a vehicle.

13. A wireless communication method of performing wireless communication between a master device and a slave device via one communication channel, which is sequentially selected from a plurality of communication channels, the wireless communication method comprising:
a detection step of detecting characteristic data indicating communication quality in the performed wireless communication, for each of the communication channels;
a deletion step of deleting the communication channel, which is determined not to satisfy a predetermined communication quality standard based on the characteristic data detected in the detection step, from the plurality of communication channels used for the wireless communication;
a determination step of determining, by deleting the communication channel in the deletion step, whether the number of the plurality of communication channels used for the wireless communication is smaller than a minimum limit value; and
a change step of changing, when a determination is made in the determination step that the number of the plurality of communication channels used for the wireless communication is smaller than the minimum limit value, the plurality of communication channels used for the wireless communication to the plurality of communication channels that satisfies a relaxed communication quality standard, which is more relaxed than the predetermined communication quality standard.
